(19) United States
(12) Patent Application Publication
(10) Pub. No.: US 2021/0356822 A1
(43) Pub. Date: Nov. 18, 2021

(54) LIQUID CRYSTAL DISPLAY PANEL

(71) Applicant: Wuhan China Star Optoelectronics technology Co., Ltd., Wuhan (CN)

(72) Inventor: Shidi Xiao, Wuhan (CN)

(21) Appl. No.: 16/325,498

(22) PCT Filed: Dec. 21, 2018
(86) PCT No.: PCT/CN2018/122764

§ 371 Date: Feb. 14, 2019

(30) Foreign Application Priority Data
Nov. 21, 2018 (CN) 201811388288.9

(51) Int. Cl. G02F 1/1362; G02F 1/1333; G02F 1/1343; G02F 1/1335

(52) U.S. Cl. CPC G02F 1/136218; G02F 1/133345; G02F 1/133357; G02F 1/136286; G02F 1/133514; G02F 1/133512; G02F 1/134309

(57) ABSTRACT

A liquid crystal display panel is provided. LCD panel includes an array substrate, a color filter substrate, and a liquid crystal layer. The color filter substrate includes black matrixes. The array substrate includes data lines corresponding to black matrixes, a planarization layer, a common electrode layer, an insulating layer, pixel electrodes, and shielding electrodes formed on the same layer as the pixel electrodes and corresponding to the data lines. The shielding electrodes are used to connect with the common electrode layer to form a shielding electric field. Liquid crystal molecules of the liquid crystal layer are not deflected within a range of the shielding electric field.

### FIELD OF DISCLOSURE

The present disclosure relates to the field of display technologies, and in particular, to a liquid crystal display panel.

### BACKGROUND

Generally, liquid crystal molecules of a liquid crystal display (LCD) are deflected by a pixel electric field, so that a backlight passes through red (R), green (G), and blue (B) photoresists to form different colors of light. Signals on a gate driver on array (GOA) and data lines are controlled by an integrated circuit (IC) to form a picture of various images. Due to light-shielding of a black matrix (BM), a corresponding light under each photoresist cannot pass through to an adjacent photoresist, so that no color shift occurs. However, in a large viewing angle state, a light-shielding effect of the BM is limited. Since a disturbance of the pixel electric field, liquid crystal under the BM is deflected by a certain angle, and the backlight under the R, G, and B photoresists can be emitted from the adjacent photoresist through the liquid crystal, thereby causing color shift in large viewing angle.

Accordingly, it is necessary to solve the technical problems in the prior art.

### SUMMARY OF THE DISCLOSURE

The present disclosure provides a liquid crystal display panel, which can improve color shift at a large viewing angle, and can reduce a width of a black matrixes, thereby increasing transmittance of a panel.

In order to solve technical problems mentioned above, technical solutions provided by the present disclosure are as follows.

The present disclosure provides a liquid crystal display panel, including: an array substrate, a color filter substrate, and a liquid crystal layer, wherein the array substrate and the color filter substrate are disposed opposite to each other, the liquid crystal layer is disposed between the array substrate and the color filter substrate, the color filter substrate includes black matrixes, and the array substrate includes:
a substrate;
data lines arranged over the substrate at intervals and corresponding to the black matrixes;
a planarization layer formed on the data lines;
a common electrode layer formed on the planarization layer;
an insulating layer formed on the common electrode layer;
a plurality of pixel electrodes formed on the insulating layer at intervals;
a plurality of shielding electrodes corresponding positions of the data lines and formed on the same layer as the pixel electrodes and insulated from the pixel electrodes,
wherein a via hole is disposed on the insulating layer, and one end of one of the shielding electrodes is connected to the common electrode layer through the via hole for forming a shielding electric field, and liquid crystal molecules of the liquid crystal layer are not deflected within a range of the shielding electric field.

In the liquid crystal display panel of the present disclosure, the shielding electrodes are distributed in a strip shape, and an extending direction of the shielding electrodes is parallel to an extending direction of the data lines.

In the liquid crystal display panel of the present disclosure, a length of one of the shielding electrodes is greater than or equal to a vertical length of an active area of the pixel electrodes.

In the liquid crystal display panel of the present disclosure, a width of one of the shielding electrodes is less than or equal to a width of one of the black matrixes.

In the liquid crystal display panel of the present disclosure, one of the shielding electrodes includes a plurality of sub-shielding electrodes, and an extending direction of each of the sub-shielding electrodes is parallel to an extending direction of the pixel electrodes.

In the liquid crystal display panel of the present disclosure, the sub-shielding electrodes have the same width and length.

In the liquid crystal display panel of the present disclosure, two adjacent sub-shielding electrodes are connected end to end through a connecting section, and shapes and sizes of connecting sections between the two adjacent sub-shielding electrodes are equal.

In the liquid crystal display panel of the present disclosure, a width of one of the shielding electrodes in a horizontal direction is less than or equal to a width of one of the black matrixes.

In the liquid crystal display panel of the present disclosure, the width of one of the shielding electrodes is a width of one of the sub-shielding electrodes and the connecting section in the horizontal direction.

The present disclosure also provides a liquid crystal display panel, including: an array substrate, a color filter substrate, and a liquid crystal layer, wherein the array substrate and the color filter substrate are disposed opposite to each other, the liquid crystal layer is disposed between the array substrate and the color filter substrate, the color filter substrate includes black matrixes, and the array substrate includes:
a substrate;
data lines arranged over the substrate at intervals and corresponding to the black matrixes;
a planarization layer formed on the data lines;
a common electrode layer formed on the planarization layer;
an insulating layer formed on the common electrode layer;
a plurality of pixel electrodes formed on the insulating layer at intervals;
a plurality of shielding electrodes corresponding positions of the data lines and formed on the same layer as the pixel electrodes and insulated from the pixel electrodes,
wherein one of the shielding electrodes is connected to the common electrode layer through a via hole for forming a shielding electric field, and liquid crystal molecules of the liquid crystal layer are not deflected within a range of the shielding electric field.

In the liquid crystal display panel of the present disclosure, the shielding electrodes are distributed in a strip shape, and an extending direction of the shielding electrodes is parallel to an extending direction of the data lines.

In the liquid crystal display panel of the present disclosure, a length of one of the shielding electrodes is greater than or equal to a vertical length of an active area of the pixel electrodes.

In the liquid crystal display panel of the present disclosure, a width of one of the shielding electrodes is less than or equal to a width of one of the black matrixes.

In the liquid crystal display panel of the present disclosure, one of the shielding electrodes includes a plurality of sub-shielding electrodes, and an extending direction of each of the sub-shielding electrodes is parallel to an extending direction of the pixel electrodes.

In the liquid crystal display panel of the present disclosure, the sub-shielding electrodes have the same width and length.

In the liquid crystal display panel of the present disclosure, two adjacent sub-shielding electrodes are connected end to end through a connecting section, and shapes and sizes of connecting sections between the two adjacent sub-shielding electrodes are equal.

In the liquid crystal display panel of the present disclosure, a width of one of the shielding electrodes in a horizontal direction is less than or equal to a width of one of the black matrixes.

In the liquid crystal display panel of the present disclosure, the width of one of the shielding electrodes is a width of one of the sub-shielding electrodes and the connecting section in the horizontal direction.

Advantages of the present disclosure are described as follows. In comparison to prior art, the liquid crystal display panel provided by the present disclosure disposes shielding electrodes made of the same material as the pixel electrodes above the data lines. The shielding electrodes are connected to the common electrode layer through the via holes on the insulating layer, so a shielding electric field is formed near the data lines to prevent the liquid crystal molecules from being affected by the pixel electrodes. It can effectively prevent color shift at a large viewing angle state and improve display quality of the panel. At the same time, since the electric field is used for shielding, a width of the black matrixes formed along with a direction of the data lines on the color filter substrate can be reduced, thereby increasing an aperture ratio of the panel, and effectively increasing transmittance of the display panel.

### BRIEF DESCRIPTION OF THE DRAWINGS

To describe the technical solutions in the embodiments or in the prior art more clearly, the following briefly introduces the accompanying drawings required for describing the embodiments or the prior art. Apparently, the accompanying drawings in the following description show merely some embodiments of the present disclosure, and a person of ordinary skill in the art may still derive other drawings from these accompanying drawings without creative efforts.

FIG. 1 is a partially schematic diagram of a liquid crystal display panel according to a first embodiment of the present disclosure.

FIG. 2 is a cross-sectional view of the liquid crystal display panel along A-A′ according to the first embodiment of the present disclosure.

FIG. 3 is a partially schematic diagram of a liquid crystal display panel according to a second embodiment of the present disclosure.

### DETAILED DESCRIPTION

The following embodiments are described with reference to the accompanying drawings, and are used to exemplify particular embodiments that the present disclosure can be used to implement. Direction terms mentioned in the present disclosure such as “upper”, “lower”, “front”, “rear”, “left”, “right”, “inner”, “outer”, and “side” are only directions with reference to the accompanying drawings. Therefore, the used direction terms are intended to describe and understand the present disclosure, but are not intended to limit the present disclosure. In the drawings, units whose structures are same are indicated using same reference numbers.

The present disclosure is directed to a prior art liquid crystal display panel. Due to disturbance of a pixel electric field, liquid crystal under black matrixes is deflected by a certain angle, thereby forming a technical problem of color shift at a large viewing angle, and embodiments of the present disclosure can solve this defect.

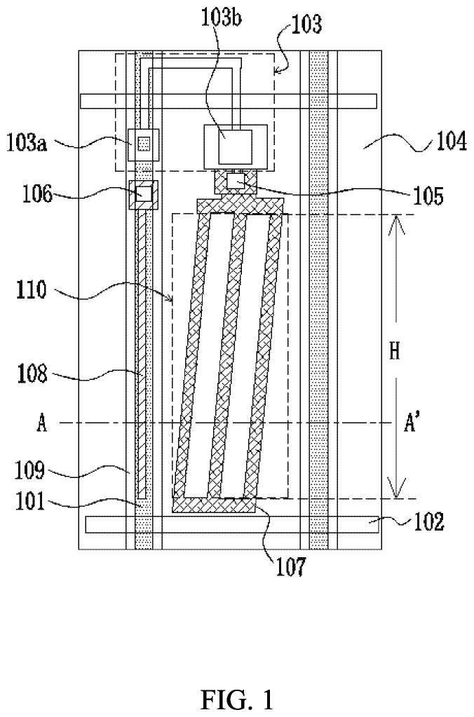

As shown in FIG. 1, FIG. 1 is a partially schematic diagram of a liquid crystal display panel according to a first embodiment of the present disclosure. The liquid crystal display panel includes data lines 101 and gate lines 102 which are arranged on the substrate, and mutually cross and are insulated from each other. The data lines 101 and the gate lines 102 define pixel areas. A thin film transistor 103 are formed on the data line 101 and the gate line 102, where a source 103a of the thin film transistor 103 is electrically connected to the data line 101. A common electrode layer 104 is provided on the thin film transistor 103, which are insulated from each other. Pixel electrodes 107 and shielding electrodes 108 are provided on the common electrode layer 104, which are insulated from each other. The pixel electrodes 107 are disposed in the pixel areas surrounded by the data lines 101 and the gate lines 102. The shielding electrodes 108 correspond to positions of the data lines.

In one embodiment, the pixel electrodes 107 and the shielding electrodes 108 are made of the same material and are simultaneously formed by the same mask process. The pixel electrodes 107 and the shielding electrodes 108 are insulated from each other. The pixel electrode 107 is electrically connected to a drain 103b of the thin film transistor 103 through a via hole 105 of the pixel electrode. The shielding electrodes 108 is electrically connected to the common electrode layer 104 through a via hole 106 of the shielding electrode 108.

The liquid crystal display panel further includes a color filter substrate (not labeled) and a liquid crystal layer (not labeled) disposed between the array substrate and the color filter substrate. The color filter substrate includes black matrixes 109. The black matrixes 109 are disposed corresponding to the data lines 101, the gate lines 102, and the thin film transistors 103. The black matrixes 109 are used for light shielding. Only the black matrixes 109 located in a direction of the data lines 101 are illustrated in the figure. A width of one of the black matrix 109 is greater than or equal to a width of one of the data lines 101.

The shielding electrodes 108 are located directly above the data lines 101 and are formed in a strip shape. An extending direction of the shielding electrodes 108 is parallel to an extending direction of the data lines 101. The via hole 106 of the shielding electrode is disposed on the insulating layer below the shielding electrodes 108. One end of the shielding electrode 108 is electrically connected to the common electrode layer 104 through via hole 106 of the shielding electrode.

A length of the shielding electrode 108 is greater than or equal to a vertical length H of the pixel electrode 107 at an active area 110. A width of the shielding electrode 108 is less than or equal to a width of the black matrix 109. A minimum width of the shielding electrode 108 is a minimum size allowed by a factory process.

The pixel electrodes 107 can generate a pixel electric field, which can deflect the liquid crystal molecules within a range of the pixel electric field, thereby realizing display. However, the pixel electric field often interferes with the liquid crystal molecules located under the data lines 101. Although there is light-shielding of the black matrixes 109, there is still a problem of light leakage under the large viewing angle. If the width of the black matrix 109 is widened, it is inevitably affected by the aperture ratio of pixels.

The present disclosure sets the shielding electrodes 108 directly above the data lines 101. Since the shielding electrodes 108 are connected to the common electrode layer 104, the shielding electrodes 108 may form a shielding electric field. The shielding electrodes 108 and the common electrode layer 104 are both at a common potential, so that the liquid crystal molecules within a range of the shielding electric field cannot be deflected. That is, the liquid crystal molecules corresponding to the position of the data lines 101 are not deflected, so that light leakage can be effectively prevented at the large viewing angle state.

In order to achieve the above purpose, a length of the shielding electrodes 108 needs to completely cover a display area that the electric field generated by the pixel electrodes 107 can interfere with, so that the length of the shielding electrodes 108 cannot be smaller than a vertical length of the pixel electrodes 107 in the active area 110. For width, to ensure its effectiveness, the width of the shielding electrodes 108 may be between a minimum size allowed by a process and the width of the black matrix 109 in the direction of the data line 101.

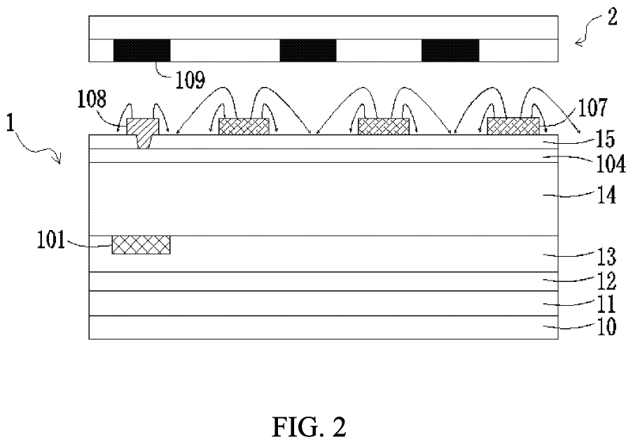

As shown in FIG. 2, which is a cross-sectional view of the liquid crystal display panel along A-A′ according to the first embodiment of the present disclosure. The liquid crystal display panel includes an array substrate 1 and a color filter substrate 2 and an intermediate liquid crystal layer (not labeled). The array substrate 1 includes a first insulating layer 11, a second insulating layer 12, a third insulating layer 13, data lines 101, a planarization layer 14, a common electrode layer 104, a fourth insulating layer 15, pixel electrodes 107, and shielding electrodes 108, where the pixel electrodes 107 and the shielding electrodes 108 located above the fourth insulating layer 15. The shielding electrodes 108 are disposed directly above the data lines 101 corresponding to the data lines 101. The shielding electrodes 108 are electrically connected to the common electrode layer 104 through via holes. The color filter substrate 2 includes black matrixes 109 corresponding to the data lines 101, where a width of the shielding electrode 108 is less than or equal to a width of the black matrix 109.

As indicated by arrows in the figure, the pixel electrodes 107 generate a pixel electric field that deflects liquid crystal molecules. The shielding electrodes 108 generate a shielding electric field at a corresponding position of the data lines 101 such that liquid crystal molecules corresponding to the position of the data lines 101 are not deflected, thereby avoiding light leakage at a large viewing angle.

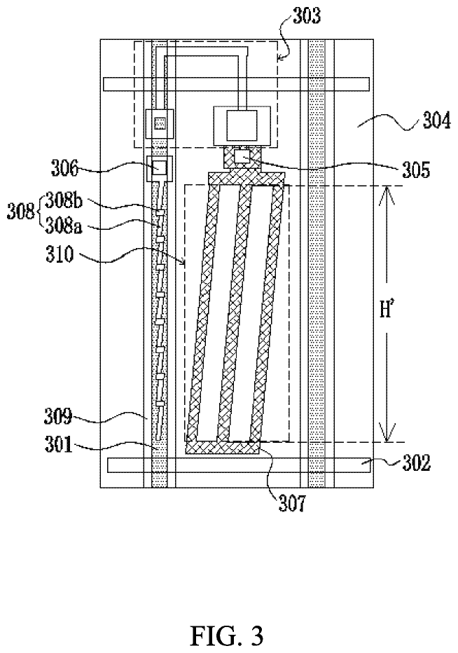

As shown in FIG. 3, FIG. 3 is a partially schematic diagram of a liquid crystal display panel according to a second embodiment of the present disclosure. The liquid crystal display panel includes: data lines 301, scan lines 302, thin film transistors 303, a common electrode layer 304, pixel electrodes 307, shielding electrodes 308, black matrixes 309, and liquid crystal layer. The data lines 301 and the gate lines 302 are arranged on the substrate, and mutually cross and are insulated from each other. The black matrixes 309 are located on the color filter substrate and correspond to the data lines 301. The liquid crystal layer is located between the array substrate and the color filter substrate. The pixel electrode 307 is connected to the thin film transistor 303 through a via hole 305 of the pixel electrode, and the shielding electrode 308 is connected to the common electrode layer 304 through a via hole 306 of the shielding electrode.

In comparison to the first embodiment, a distinguishing feature of the second embodiment is that the shielding electrode 308 includes sub-shielding electrodes 308a arranged in multiple sections, and an extending direction of each of the sub-shielding electrodes 308a is parallel to an extending direction of the pixel electrodes 307. Two adjacent sub-shielding electrodes 308a are connected end to end through a connecting section 308b.

In one embodiment, each of the sub-shielding electrodes 308a has the same width and length. Also, shapes of the connecting sections 308b between two adjacent sub-shielding electrodes 308a are equal.

A length of a straight line between both ends of the shielding electrode 308 is greater than or equal to a vertical length H′ of the pixel electrode 307 at an active area 310. A width of the shielding electrodes 308 in a horizontal direction is less than or equal to a width of the black matrix 309. A minimum width of the shielding electrode 308 is a minimum size allowed by a factory process. The width of the shielding electrodes 308 is a width of the sub-shielding electrode 308a and the connecting section 308b in the horizontal direction.

The present disclosure sets the shielding electrodes 308 directly above the data lines 301. Since the shielding electrodes 308 are connected to the common electrode layer 304, the shielding electrodes 308 may form a shielding electric field. The shielding electrodes 308 and the common electrode layer 304 are both at a common potential, so that the liquid crystal molecules within a range of the shielding electric field cannot be deflected. That is, the liquid crystal molecules corresponding to the position of the data lines 301 are not deflected, so that light leakage can be effectively prevented at the large viewing angle state.

In order to achieve the above purpose, a length of the shielding electrodes 308 needs to completely cover a display area that the electric field generated by the pixel electrodes 307 can interfere with, so that the length of the shielding electrodes 308 cannot be smaller than a vertical length of the pixel electrodes 307 in the active area 310. For width, to ensure its effectiveness, the width of the shielding electrodes 108 may be between a minimum size allowed by a process and the width of the black matrix 309 in the direction of the data line 301.

The liquid crystal display panel provided by the present disclosure disposes shielding electrodes made of the same material as the pixel electrodes above the data lines. The shielding electrodes are connected to the common electrode layer through the via holes on the insulating layer, so a shielding electric field is formed near the data lines to prevent the liquid crystal molecules from being affected by the pixel electrodes. It can effectively prevent color shift at a large viewing angle state and improve display quality of the panel. At the same time, since the electric field is used for shielding, a width of the black matrixes formed along with a direction of the data lines on the color filter substrate can be reduced, thereby increasing an aperture ratio of the panel, and effectively increasing transmittance of the display panel.

In conclusion, although the present disclosure has been disclosed through the preferred embodiments as above, the above preferred embodiments are not intended to limit the present disclosure. A person of ordinary skill in that art can make various modification and improvements without departing from the spirit and scope of the present disclosure. Therefore, the protection scope of the present disclosure is subject to the scope defined by the claims.

What is claimed is:

1. A liquid crystal display panel, comprising: an array substrate, a color filter substrate, and a liquid crystal layer, wherein the array substrate and the color filter substrate are disposed opposite to each other, the liquid crystal layer is disposed between the array substrate and the color filter substrate, the color filter substrate comprises black matrixes, and the array substrate comprises:
a substrate;
data lines arranged over the substrate at intervals and corresponding to the black matrixes;
a planarization layer formed on the data lines;
a common electrode layer formed on the planarization layer;
an insulating layer formed on the common electrode layer;
a plurality of pixel electrodes formed on the insulating layer at intervals;
a plurality of shielding electrodes corresponding positions of the data lines and formed on the same layer as the pixel electrodes and insulated from the pixel electrodes,
wherein a via hole is disposed on the insulating layer, and one end of one of the shielding electrodes is connected to the common electrode layer through the via hole for forming a shielding electric field, and liquid crystal molecules of the liquid crystal layer are not deflected within a range of the shielding electric field.

2. The liquid crystal display panel as claimed in claim 1, wherein the shielding electrodes are distributed in a strip shape, and an extending direction of the shielding electrodes is parallel to an extending direction of the data lines.

3. The liquid crystal display panel as claimed in claim 1, wherein a length of one of the shielding electrodes is greater than or equal to a vertical length of an active area of the pixel electrodes.

4. The liquid crystal display panel as claimed in claim 1, wherein a width of one of the shielding electrodes is less than or equal to a width of one of the black matrixes.

5. The liquid crystal display panel as claimed in claim 1, wherein one of the shielding electrodes comprises a plurality of sub-shielding electrodes, and an extending direction of each of the sub-shielding electrodes is parallel to an extending direction of the pixel electrodes.

6. The liquid crystal display panel as claimed in claim 5, wherein the sub-shielding electrodes have the same width and length.

7. The liquid crystal display panel as claimed in claim 5, wherein two adjacent sub-shielding electrodes are connected end to end through a connecting section, and shapes and sizes of connecting sections between the two adjacent sub-shielding electrodes are equal.

8. The liquid crystal display panel as claimed in claim 7, wherein a width of one of the shielding electrodes in a horizontal direction is less than or equal to a width of one of the black matrixes.

9. The liquid crystal display panel as claimed in claim 8, wherein the width of one of the shielding electrodes is a width of one of the sub-shielding electrodes and the connecting section in the horizontal direction.

10. A liquid crystal display panel, comprising: an array substrate, a color filter substrate, and a liquid crystal layer, wherein the array substrate and the color filter substrate are disposed opposite to each other, the liquid crystal layer is disposed between the array substrate and the color filter substrate, the color filter substrate comprises black matrixes, and the array substrate comprises:
a substrate;
data lines arranged over the substrate at intervals and corresponding to the black matrixes;
a planarization layer formed on the data lines;
a common electrode layer formed on the planarization layer;
an insulating layer formed on the common electrode layer;
a plurality of pixel electrodes formed on the insulating layer at intervals;
a plurality of shielding electrodes corresponding positions of the data lines and formed on the same layer as the pixel electrodes and insulated from the pixel electrodes,
wherein one of the shielding electrodes is connected to the common electrode layer through a via hole for forming a shielding electric field, and liquid crystal molecules of the liquid crystal layer are not deflected within a range of the shielding electric field.

11. The liquid crystal display panel as claimed in claim 10, wherein the shielding electrodes are distributed in a strip shape, and an extending direction of the shielding electrodes is parallel to an extending direction of the data lines.

12. The liquid crystal display panel as claimed in claim 10, wherein a length of one of the shielding electrodes is greater than or equal to a vertical length of an active area of the pixel electrodes.

13. The liquid crystal display panel as claimed in claim 10, wherein a width of one of the shielding electrodes is less than or equal to a width of one of the black matrixes.

14. The liquid crystal display panel as claimed in claim 10, wherein one of the shielding electrodes comprises a plurality of sub-shielding electrodes, and an extending direction of each of the sub-shielding electrodes is parallel to an extending direction of the pixel electrodes.

15. The liquid crystal display panel as claimed in claim 14, wherein the sub-shielding electrodes have the same width and length.

16. The liquid crystal display panel as claimed in claim 14, wherein two adjacent sub-shielding electrodes are connected end to end through a connecting section, and shapes and sizes of connecting sections between the two adjacent sub-shielding electrodes are equal.

17. The liquid crystal display panel as claimed in claim 16, wherein a width of one of the shielding electrodes in a horizontal direction is less than or equal to a width of one of the black matrixes.

18. The liquid crystal display panel as claimed in claim 17, wherein the width of one of the shielding electrodes is a width of one of the sub-shielding electrodes and the connecting section in the horizontal direction.
